(19) United States
(12) Patent Application Publication
(10) Pub. No.: US 2023/0203323 A1
(43) Pub. Date: Jun. 29, 2023

(54) Improved Non-Stick Coating

(71) Applicant: SEB S.A., Ecully (FR)

(72) Inventors: Raphaël Turgis, Ecully Cedex (FR); Isabelle Joutang, Ecully Cedex (FR); Stephanie Le Bris, Ecully Cedex (FR)

(73) Assignee: SEB S.A., Ecully (FR)

(21) Appl. No.: 17/925,972

(22) PCT Filed: May 18, 2021
(86) PCT No.: PCT/FR2021/050876

§ 371 Date: Nov. 17, 2022

(30) Foreign Application Priority Data
May 19, 2020 (FR) 2005073

(51) Int. Cl. C09D 7/61; C09D 123/28

(52) U.S. Cl. CPC C09D 7/61; C09D 123/28

(57) ABSTRACT

The purpose of the present invention is the use of (Bi₁₋ₓAₓ)(V_{1-y}M_{y})0₄ in a non-stick coating for a household article so as to reduce or prevent the color change of said coating during the manufacturing process thereof, characterised in that: —x is equal to 0 or x is from 0.001 to 0.999; —y is equal to 0 or y is from 0.001 to 0.999; —A and Mare selected from the group consisting of nitrogen, phosphorus, an alkali metal, an alkaline earth metal, a transition metal, a poor metal, a metalloid or a lanthanide; —A and M are different from each other.

The invention concerns non-stick coatings for household articles, preferably cookware.

Non-stick household articles having a fluoropolymer-based coating currently consist of, among others, a PTFE fluoropolymer but can also incorporate one or more bonding resins, such as PAI, PES, PAEK (polyaryletherketone), tannins, and/or organic additives such as acrylic derivatives.

The disadvantage of these resins and these additives is that they tend to partially degrade when PTFE is sintered and generate degradation by-products. The by-products created thus contribute to a yellowing to the entire article. This yellowing is all the more visible when a light-coloured decoration is applied between the primer coats and the finish coat.

The compound BiVO₄ is currently known as a photocatalyst making it possible to degrade organic compounds and therefore remove pollution from the atmosphere. However, to be active, this catalyst requires light. Moreover, the degradation kinetics are often very long (several hours).

More recently, it has been shown that BiVO₄ can be used to completely break down methylbenzene by combining a temperature reaction and under light irradiation. Nevertheless, it is not mentioned that BiVO₄ allows only a thermal degradation of methylbenzene (CN102008892).

Surprisingly, the inventors have observed that these yellowing phenomena, generally at the end of a high-temperature manufacturing process of non-stick coatings, can be resolved by adding BiVO₄ in one of the coats of the coating. The inventors have actually observed that a yellow decoration can be obtained by adding BiVO₄ without degrading the initial colour. BiVO₄ therefore protects the colour of the coat in which it is added. Moreover, the inventors have also shown that it can protect the colour of a coat superposed on that in which it is added.

### SUMMARY OF THE INVENTION

A first subject-matter of the invention concerns the use of (Bi₁₋ₓAₓ)(V_{1-y}M_{y})O₄ in a non-stick coating for household articles, in order to reduce or prevent the colour change of said coating during the manufacturing process thereof, characterised in that:
x is equal to 0 or x is between 0.001 and 0.999,
y is equal to 0 or y is between 0.001 and 0.999,
A and M are chosen in the group consisting of nitrogen, phosphorus, an alkali metal, an alkaline earth metal, a transition metal, a poor metal, a metalloid or a lanthanide,
A and M are different from one another.

### Definitions

“Room temperature” is understood to mean a temperature between 18 and 30° C.

Within the meaning of the present invention, “coat” should be understood to mean a continuous or discontinuous coat. A continuous coat (also called a monolithic coat) is a single whole forming a total solid colour completely covering the surface on which it is put down. A discontinuous coat (or non-monolithic coat) can comprise several parts so is not a single whole.

“Primer coat”, “bonding coat” or “bonding primer” is understood to mean all the coats from the first coat applied directly to the support, also called substrate, (it is preferable that this coat adheres well to the support and provides all its mechanical properties to the coating: hardness, scratch resistance) to the last coat before the first decorative coat.

“Finish coat” or “finish” is understood to mean a continuous and transparent surface coat leaving the decorative coat perfectly visible while protecting it from mechanical damage and conferring its non-stick properties to the coating.

“Decoration” or “decorative coat” is understood to mean one or several continuous or discontinuous coats comprising a pigment composition. The decoration can be in the form of one or more patterns and one or more colours. A decoration is distinctly visible to the user with the naked eye and at a standard distance of use for the household article.

The expression “household article” should be understood to mean cookware and household appliances.

The household appliances in question here are intended to produce heat.

Within the meaning of the present invention, “cookware” should be understood to mean an object intended for cooking. For this purpose, it is intended to receive a heat treatment.

Within the meaning of the present invention, “object intended to receive a heat treatment” should be understood to mean an object which will be heated by an external heating system such as frying pans, saucepans, sauté pans, woks or barbecue grills, and which is able to transmit the calorific energy provided by this external heating system to a material or food in contact with said object.

Within the meaning of the present invention, “object intended to produce heat” should be understood to mean a heating object having its own heating system such as clothing irons, hair straighteners, steam generators, electric kettles or electrical appliances for cooking.

“Fluoropolymer-based coating” is understood to mean a coating which comprises one or more fluoropolymers in one or more of its coats.

Within the meaning of the present invention, “sol-gel coating” is understood to mean a coating synthesised by the sol-gel route from a solution based on precursors in the liquid phase, which is transformed into a solid by a set of chemical reactions (hydrolysis and condensation) at low temperature. The coating thus obtained can be either organo-mineral or entirely mineral.

Within the meaning of the present invention, “organo-mineral coating” is understood to mean a coating whose network is essentially inorganic but which comprises organic groups, in particular because of the precursors used and the curing temperature of the coating.

Within the meaning of the present invention, “entirely mineral coating” is intended to mean a coating made up of an entirely inorganic material, free of any organic groups. Such a coating can also be obtained by the sol-gel route with a curing temperature of at least 400° C. or from precursors of the tetraethoxysilane (TEOS) type with a curing temperature which may be less than 400° C.

### FIGURES

FIG. 1: pattern distribution diagram in a two-decoration configuration. 1A=adjacent, non-overlapping patterns. 1B=partially overlapping patterns. 1C=overlapping patterns.

### DETAILED DESCRIPTION

A first subject-matter of the invention concerns the use of (Bi₁₋ₓAₓ)(V_{1-y}M_{y})O₄ in a non-stick coating for household articles in order to reduce or prevent the colour change of said coating during the manufacturing process thereof, characterised in that:
x is equal to 0 or x is between 0.001 and 0.999,
y is equal to 0 or y is between 0.001 and 0.999,
A and M are chosen in the group consisting of nitrogen, phosphorus, an alkali metal, an alkaline earth metal, a transition metal, a poor metal, a metalloid or a lanthanide,
A and M are different from one another.

(Bi₁₋ₓAₓ)(V_{1-y}M_{y})O₄ is added in one or more coats of said non-stick coating. Preferably, the amount of (Bi₁₋ₓAₓ)(V_{1-y}M_{y})O₄ in the or each of the coats into which it is added is comprised from 0.1 to 100% by weight relative to the weight of said coat in the dry state, preferably 0.2 to 80% by weight, more preferably 0.5 to 70% by weight. (Bi₁₋ₓAₓ)(V_{1-y}M_{y})O₄ can be applied pure and continuously or discontinuously.

Advantageously, the (Bi₁₋ₓAₓ)(V_{1-y}M_{y})O₄ compound is present in the form of particles consisting of the (Bi₁₋ₓAₓ)(V_{1-y}M_{y})O₄ compound. “In the form of particles consisting of the (Bi₁₋ₓAₓ)(V_{1-y}M_{y})O₄ compound” means that the particles are purely made of the (Bi₁₋ₓAₓ)(V_{1-y}M_{y})O₄ compound. They are therefore not coated. Advantageously, they are rough.

During its manufacturing process, the coating can undergo high temperatures, for example comprised from 150 to 450° C.

These high temperatures can be responsible for a colour change of the coating.

The term “reduce or prevent the colour change” preferably means reduce or prevent the colour change visible to the naked eye.

Preferably, the (Bi₁₋ₓAₓ)(V_{1-y}M_{y})O₄ compound as defined above exhibits a monoclinic scheelite crystallographic form at room temperature.

Preferably, x and y are 0, i.e. the invention relates to the use of bismuth vanadate (BiVO₄). Advantageously, a BiVO₄ compound of monoclinic scheelite crystallographic form at room temperature is used.

Bismuth vanadate is an inorganic compound of yellow colour, of formula BiVO₄, widely used for its colour properties and for its absence of toxicity. Recorded in the Colour Index International database as Q. I. Pigment Yellow 184, it is especially sold by the companies Heubach (Vanadur®), BASF (Sicopal®), FERRO (Lysopac) or Bruchsaler Farbenfabrik (Brufasol®).

This compound has been the subject of many studies due to its intense colour and to its thermochromism. Many synthesis pathways can be considered for producing BiVO₄ nanoparticles, such as sol-gel synthesis, pyrolysis of precursors, hydrothermal and solvothermal syntheses and gas phase deposition. Hydrothermal synthesis can be complex from the mechanistic viewpoint due to the simultaneous formation of stable and unstable phases in the event of rapid heating in a pressurised autoclave. The abundance of phases and the complexity of the phase diagram of the products obtained by hydrothermal synthesis make it difficult to form and stabilise one or the other of the crystallographic phases.

The second, more commonly used synthesis pathway is a solid phase sintering method. It has the advantage of easily obtaining large-scale powders with a high degree of crystallinity at a low cost. BiVO₄ particles can thus be obtained by annealing a mixture of bismuth and vanadium salts via a high-temperature sintering process. The microstructure obtained (particle size, morphology, crystallinity) and optional doping elements may affect the band gap of BiVO₄, with as a consequence, a modification of its initial colour and/or thermochromism.

Given that A and M are different from one another, when:
A is an alkali metal, it can be chosen from Li, Na, K, Rb and Cs,
M is an alkali metal, it can be chosen from Li, Na, K, Rb and Cs,
A is an alkaline-earth metal, it can be chosen from Be, Mg, Ca, Sr and Ba,
M is an alkaline-earth metal, it can be chosen from Be, Mg, Ca, Sr and Ba,
A is a transition metal, it can be chosen from Sc, Ti, Cr, Mn, Fe, Co, Ni, Cu, Y, Zr, Nb, Mo, Ru, Rh, Pd, Ag, Ta, W and Jr,
M is a transition metal, it can be chosen from Sc, Ti, Cr, Mn, Fe, Co, Ni, Cu, Y, Zr, Nb, Mo, Ru, Rh, Pd, Ag, Ta, W and Jr,
A is a poor metal, it can be chosen from Al, Zn, Ga, In and Sn,
M is a poor metal, it can be chosen from Al, Zn, Ga, In and Sn,
A is a metalloid, it can be chosen from B, Si, Ge and Sb,
M is a metalloid, it can be chosen from B, Si, Ge and Sb,
A is a lanthanide, it can be chosen from La, Ce, Pr, Nd, Pm, Sm, Eu, Gd, Tb, Dy, Ho, Er, Tm, Yb and Lu,
M is a lanthanide, it can be chosen from La, Ce, Pr, Nd, Pm, Sm, Eu, Gd, Tb, Dy, Ho, Er, Tm, Yb and Lu.

Preferably A and M different from one another are B and/or Mg.

Preferably, said coating comprises, in the following order from the face of the substrate of the household article on which it will be applied: one or more primer coats, optionally, one or more continuous or discontinuous decorative coats, and one or more finish coats.

Preferably, said coating comprises, in the following order from the face of the substrate of the household article: one or two primer coats, optionally a decorative coat and a finish coat.

In the case of a configuration with no decoration, (Bi₁₋ₓAₓ)(V_{1-y}M_{y})O₄ is added in at least one primer coat and/or at least one finish coat. It is, for example, added in a primer coat to protect against colour change of the finish coats. It is, for example, added into one or more finish coats in order to protect it or them against a colour change.

According to another embodiment, the coating according to the invention is an organo-mineral or entirely mineral sol-gel (SG) coating. These coatings synthesised by the sol-gel pathway from precursors of the metal poly alkoxylate type have a hybrid network, generally of silica with grafted alkyl groups. A sol-gel (SG) composition comprises at least one colloidal metal oxide and at least one metal alkoxide type precursor.

The metal alkoxide is preferably a colloidal metal oxide chosen from colloidal silica and/or colloidal alumina.

A metal alkoxide is preferably used as a precursor chosen in the group consisting of:
the precursors corresponding to the general formula M₁(OR₁)ₙ,
the precursors corresponding to the general formula M₂(OR₂)₍ₙ₋₁₎R₂′, and
the precursors corresponding to the general formula M₃(OR₃)₍ₙ₋₂₎R_{3′2}, with: R₁, R₂, R₃ or R₃′ designating an alkyl group,
R₂′ designating an alkyl or phenyl group,
n being a whole number corresponding to the maximum valence of the metals M₁, M₂ or M₃,
M₁, M₂ or M₃ designating a metal chosen from Si, Zr, Ti, Sn, Al, Ce, V, Nb, Hf, Mg or Ln.

Advantageously, the metal alkoxide of the sol-gel solution is an alkoxysilane.

Alkoxysilanes which can be used in the sol-gel solution of the method of the invention can particularly include methyltrimethoxysilane (MTMS), tetraethoxysilane (TEOS), methyltriethoxysilane (MTES), dimethyldimethoxysilane, and mixtures thereof.

Preferably, the alkoxysilanes MTES and TEOS will be used, because they have the advantage of not containing methoxy groups. Indeed, methoxy hydrolysis leads to the formation of methanol in the sol-gel formulation, which, given its toxic class, requires additional precautions during application. In contrast, hydrolysis of ethoxy groups only generates ethanol, having a more favourable class and therefore less restrictive using requirements for the sol-gel coating.

The formation of this sol-gel coating consists of mixing an aqueous composition A comprising the colloidal metal oxide and a solution B comprising the metal alkoxide. The mixture is advantageously done in a ratio of 40 to 75% by weight of the aqueous composition relative to the weight of the sol-gel composition (A+B), so that the quantity of colloidal metal oxide represents 5 to 30% by weight of the sol-gel composition (A+B) in the dry state.

Aqueous composition A can also comprise a solvent, in particular a solvent comprising at least one alcohol.

Aqueous composition A can also comprise at least one silicone oil.

Aqueous composition A can also comprise a pigment.

Aqueous composition A can also comprise a mineral filler.

Aqueous composition A can also comprise fumed silica, whose function is to regulate the viscosity of the sol-gel composition and/or the gloss of the dry coating.

Aqueous composition A typically comprises for a primer coat:
i) 5 to 30% by weight relative to the total weight of aqueous composition A of at least one colloidal metal oxide;
ii) 0 to 20% by weight relative to the weight of composition A of a solvent comprising at least one alcohol;
iii) optionally, 0.05 to 3% by weight relative to the total weight of said aqueous composition A of at least one silicone oil;
iv) 5 to 30% of pigment;
v) 2 to 30% of mineral filler.

Aqueous composition A typically comprises for a finish coat:
i) 5 to 30% by weight relative to the total weight of aqueous composition A of at least one colloidal metal oxide;
ii) 0 to 20% by weight relative to the weight of composition A of a solvent comprising at least one alcohol;
iii) optionally, 0.05 to 3% by weight relative to the total weight of said aqueous composition A of at least one silicone oil;
iv) 0.1 to 1% of metallic glitter.

Solution B can also comprise a Bronsted or Lewis acid. Advantageously, the metal alkoxide precursor of solution B is mixed with an organic or mineral Lewis acid which represents from 0.01 to 10% by weight of the total weight of solution B.

Particular examples of acids usable for mixture with the metal alkoxide precursor are acetic acid, citric acid, ethyl acetoacetate, hydrochloric acid or formic acid.

Solution B can also comprise a solvent, in particular a solvent comprising at least one alcohol.

Solution B can also comprise at least one silicone oil.

Solution B can also comprise metallic glitter.

According to an advantageous embodiment of the process of the invention, solution B can comprise a mixture of one of the alkoxysilanes such as defined above and an aluminium alcoholate.

According to this sol-gel embodiment, the coating according to the invention can comprise, in this order, from the face of the substrate:
One or more SG primer coats,
A decoration over at least a part of the last primer coat comprising the BiVO₄ pigment compound such as defined above.

According to another embodiment, the coating according to the invention is a fluoropolymer-based coating.

The fluoropolymer(s) can be present in the form of powder or aqueous dispersion or mixtures thereof.

Advantageously, the fluoropolymer(s) can be chosen in the group comprising polytetrafluoroethylene (PTFE), copolymers of tetrafluoroethylene and perfluoropropyl vinyl ether (PFA), copolymers of tetrafluoroethylene and hexafluoropropene (FEP), polyvinylidene fluoride (PVDF), copolymers of tetrafluoroethylene and polymethyl vinyl ether (MVA), terpolymers of tetrafluoroethylene, polymethyl vinyl ether and fluoroalkyl vinyl ether (TFE/PMVE/FAVE), ethylene tetrafluoroethylene (ETFE) and mixtures thereof.

Advantageously, the fluoropolymer(s) can be chosen from polytetrafluoroethylene (PTFE), copolymers of tetrafluoroethylene and perfluoropropyl vinyl ether (PFA), copolymers of tetrafluoroethylene and hexafluoropropene (FEP), a mixture of PTFE and PFA (PTFE/PFA) and a mixture of PTFE and FEP (PTFE/FEP).

Preferably, the fluoropolymer(s) can represent from 10 to 99% by mass, preferably from 50 to 98% by mass of the total dry mass of the non-stick coating composition.

Preferably, said coating comprises one or more decorations.

Preferably, (Bi₁₋ₓAₓ)(V_{1-y}M_{y})O₄ is then added into at least one of the decorations or into a primer coat, in a particularly preferred manner in at least one of the decorations or in the last primer coat onto which the decoration(s) will be applied.

According to a first embodiment, (Bi₁₋ₓAₓ)(V_{1-y}M_{y})O₄ is added into a coat in order to reduce or prevent the colour change of this coat. For example, (Bi₁₋ₓAₓ)(V_{1-y}M_{y})O₄ is added into a decoration in order to reduce or prevent the colour change of this decoration. According to a sub-embodiment, the (Bi₁₋ₓAₓ)(V_{1-y}M_{y})O₄ compound is added into a coat both in order to reduce or prevent the colour change of this coat, and also as a pigment to colour said coat.

A yellow decoration can be considered, for example, comprising (Bi₁₋ₓAₓ)(V_{1-y}M_{y})O₄, the (Bi₁₋ₓAₓ)(V_{1-y}M_{y})O₄ being used both to give the decoration its yellow colour as well as to protect it from a colour change. This yellow decoration can be made up of (Bi₁₋ₓAₓ)(V_{1-y}M_{y})O₄.

According to a second embodiment, (Bi₁₋ₓAₓ)(V_{1-y}M_{y})O₄ is added into a coat in order to reduce or prevent the colour change of another coating coat, in particular a coat superposed on this coat. For example, (Bi₁₋ₓAₓ)(V_{1-y}M_{y})O₄ is added into a coat applied under a decoration, for example a primer coat, in order to reduce or prevent the colour change of this decoration. According to a sub-embodiment, the (Bi₁₋ₓAₓ)(V_{1-y}M_{y})O₄ compound is added in a quantity such that it does not colour the coat in which it is added.

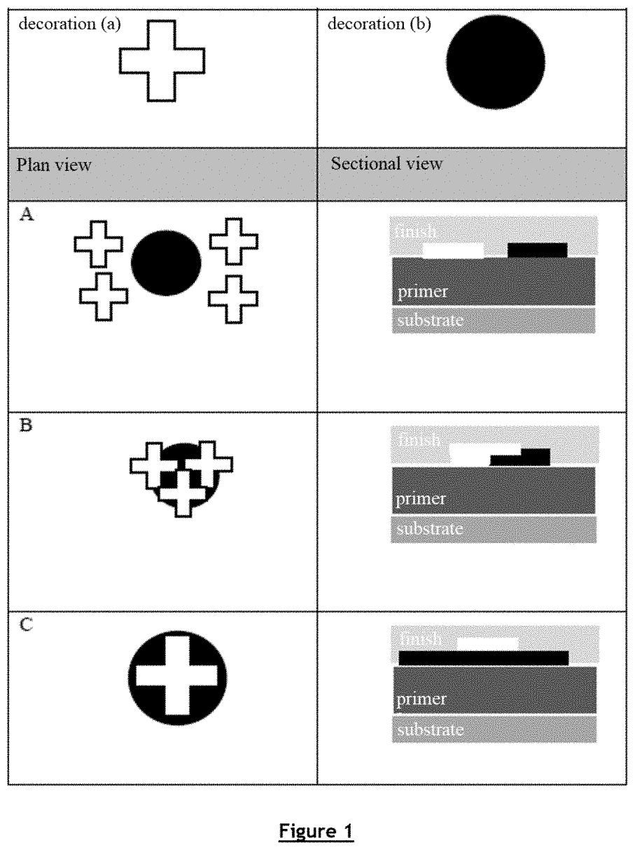

For example, a white decoration comprising (Bi₁₋ₓAₓ)(V_{1-y}M_{y})O₄ can be considered in the form of patterns and a yellow decoration in the form of different patterns overlapping the white patterns (see FIG. 1C), (Bi₁₋ₓAₓ)(V_{1-y}M_{y})O₄ being used in order to protect the yellow decoration from a colour change. This yellow decoration can consist of (Bi₁₋ₓAₓ)(V_{1-y}M_{y})O₄. “Overlapping coats” is understood to mean partially or completely superposed coats. These coats can be in the form of decoration with partially overlapping patterns, for example concentric disks.

The decorations can be applied by any method well known to the skilled person such as, for example, by screen printing or pad printing.

Advantageously, the article support can be plastic, metal, glass, ceramic or terracotta. Metal supports usable in the context of the present invention advantageously include supports of aluminium or aluminium alloy, anodised or not, or of polished, brushed or bead-blasted, sandblasted, chemically treated aluminium or aluminium alloy, or polished stainless steel, or cast iron or aluminium, or titanium or hammered or polished copper.

The primer coat(s) can comprise a bonding resin, especially when the substrate is mechanically treated.

Preferably, the bonding resin(s) is (are) chosen in the group consisting of polyamide-imides (PAI), polyether imides (PEI), polyamides (PA), polyimides (PI), polyetherketones (PEK), polyetheretherketones (PEEK), polyaryletherketones (PAEK), polyethersulfones (PES), and polyphenylene sulfide (PPS), polybenzimidazoles (PBI), tannins.

Examples of household articles usable in the context of the present invention can notably include deep fryer bowls, fondue or raclette pans or pots, the bowl of a deep fryer or bread machine, the jar of a blender, the plates of a straightening iron (said coating is intended to cover the plates of said straightening iron) and the iron soleplates (said coating is intended to cover the soleplate of said iron).

Preferably, said household article is an article of cookware, preferably chosen in the group consisting of a saucepan, frying pan, stew pot, wok, sauté pan, crepe maker, grill, plancha grill, raclette grill, marmite pot or casserole dish, and said coating is intended to come into contact with food.

In the fields of application considered for the present invention, an article to be heated of the cookware type or a heating article of the iron type is typically used in a range of temperatures comprised between 10° C. and 300° C.

The use according to the invention can make it possible to reduce or prevent the colour change of said coating during the sintering step of its manufacturing process.

### EXAMPLES

### Example 1: Process for Synthesising a BiVO₄ Compound Used According to the Invention

### Process 1.1

To a solution of bismuth nitrate (0.1 M) in 1 M nitric acid is added stoichiometrically a solution of ammonium vanadate (0.1 M) in 1 M nitric acid. The mixture is stirred overnight, filtered, washed with water and then dried. The powder is then annealed at 450° C. for 3 hours. The bismuth vanadate is then obtained in the form of a bright yellow powder of monoclinic scheelite structure characterised by x-ray diffraction analysis.

The process takes place at pH<1 without no addition of alkaline agent.

### Process 1.2

To a solution of bismuth nitrate (0.4 M) in 1 M nitric acid is added a stoichiometric quantity of sodium metavanadate in the powder form. The mixture is stirred for 2 hours at 80° C. The precipitate is then filtered and washed with water to obtain a yellow BiVO₄ powder in the monoclinic scheelite form. The powder is then annealed at 500° C. for 3 hours.

The process takes place at pH<1 with no addition of alkaline agent.

The monoclinic scheelite BiVO₄ thus has ΔE=40 between room temperature and 200° C.

### Example 2: BiVO₄ Compounds Tested

The following BiVO₄ compounds have been tested and compared for their effect on the protection from a colour change of the coat in which they are added or an adjacent coat:
BiVO₄ of example 1
BiVO₄ sold under the reference Sicopal® Yellow K1120FG (BASF)

### Example 3: Formulations

(a) Primer 1/Formula 1a

| | weight % | weight % |
|---|---|---|
| Component | wet formula | dry film |
| fluorinated polymer aqueous dispersion | 24 | 60 |
| carbon black aqueous dispersion | 4 | 4 |
| colloidal silica | 16 | 20 |
| bonding resin solvent dispersion | 41 | 16 |
| additives (base, wetting agents, etc.) | 6 | — |
| Water | 9 | — |

(b) Primer 2/Formula 2a

| | weight % | weight % |
|---|---|---|
| Component | wet formula | dry film |
| fluorinated polymer aqueous dispersion | 48 | 88 |
| carbon black aqueous dispersion | 5 | 4 |
| colloidal silica | 3 | 3 |
| bonding resin solvent dispersion | 19 | 5 |
| additives (base, wetting agents, etc.) | 12 | — |
| Water | 13 | — |

(c) Primer 2/Formula 2b

| | weight % | weight % |
|---|---|---|
| Component | wet formula | dry film |
| fluorinated polymer aqueous dispersion | 48 | 87 |
| carbon black aqueous dispersion | 4 | 3 |
| pigment paste based on the BiVO₄ | 9 | 3 |
| of Example 1 | | |
| colloidal silica | 3 | 3 |
| bonding resin solvent dispersion | 19 | 4 |
| additives (base, wetting agents, etc.) | 12 | — |
| Water | 5 | — |

(d) White Decoration 3/Formula 3a

| | weight % | weight % |
|---|---|---|
| Component | wet formula | dry film |
| fluorinated polymer aqueous dispersion | 54 | 72 |
| pigment paste based on TiO₂ | 25 | 28 |
| propylene glycol | 10 | — |
| thickening agent | 2 | — |
| additives (base, wetting agents, etc.) | 2 | — |
| Water | 7 | — |

(e) White Decoration 3/Formula 3b

| | weight % | weight % |
|---|---|---|
| Component | wet formula | dry film |
| fluorinated polymer aqueous dispersion | 54 | 74.3 |
| pigment paste based on TiO₂ | 18 | 24.8 |
| pigment paste based on the BiVO₄ | 0.7 | 1.0 |
| of Example 1 | | |
| propylene glycol | 10 | — |
| thickening agent | 2 | — |
| additives (base, wetting agents, etc.) | 2.3 | — |
| Water | 13 | — |

(f) Yellow Decoration 3/Formula 3c

| | weight % | weight % |
|---|---|---|
| Component | wet formula | dry film |
| fluorinated polymer aqueous dispersion | 54 | 72 |
| pigment paste based on the BiVO₄ | 25 | 28 |
| of Example 1 | | |
| propylene glycol | 10 | — |
| thickening agent | 2 | — |
| additives (base, wetting agents, etc.) | 2 | — |
| Water | 7 | — |

(g) Yellow Decoration 3/Formula 3d

| | weight % | weight % |
|---|---|---|
| Component | wet formula | dry film |
| fluorinated polymer aqueous dispersion | 54 | 72 |
| pigment paste based on Sicopal ® K1120FG | 25 | 28 |
| propylene glycol | 10 | — |
| thickening agent | 2 | — |
| additives (base, wetting agents, etc.) | 2 | — |
| Water | 7 | — |

(h) Finish 4

| | weight % | weight % |
|---|---|---|
| Component | wet formula | dry film |
| fluorinated polymer aqueous dispersion | 93 | 99 |
| Glitter | 1 | 1 |
| additives (base, wetting agents, etc.) | 3 | — |
| ethylene glycol | 2 | — |
| Water | 1 | — |

### Example 4: Configurations

### a. Configuration 1: Primer Coat 1 without BiVO₄, Primer Coat 2 with/without the BiVO₄ of Example 1 and White Decoration without BiVO₄

A primer coat 1 of formula 1a is first deposited on the aluminium substrate. After drying, a primer coat 2 of formula 2b is coated onto primer coat 1. After drying, a white decoration 3 of formula 3a is deposited onto the primer coat 2. After drying, a finish coat of formula 4 is coated onto the primer coat 2 and the decoration. The article is then sintered at 430° C. for 11 minutes.

Appearance: the decoration remains white with L*a*b* values=83, 0.4, 12. The decoration is protected from a colour change during the process of manufacturing the coating by the BiVO₄ contained in the primer coat 2 applied under the decoration.

In contrast, the same configuration with the only difference that the primer coat 2 is of formula 2a (without BiVO₄), has the consequence that the decoration after sintering is not white but golden yellow with the L*a*b * values=70.8; 2.8; 14.8.

### b. Configuration 2: Two Primer Coats without BiVO₄, Decoration with/without BiVO₄

A primer coat 1 of formula 1a is first deposited on the aluminium substrate. After drying, a primer coat 2 of formula 2a is coated onto the primer coat 1. After drying, a white decoration of formula 3b is deposited onto the primer coat 2. After drying, a finish coat of formula 4 is coated onto the primer coat 2 and the decoration. The article is then sintered at 430° C. for 11 minutes.

Appearance: the decoration remains white with L*a*b* values=83, 0.4, 12. The decoration is protected from a colour change during the process of manufacturing the coating by the BiVO₄ contained in this decoration.

In contrast, the same configuration with the only difference that the decoration is white of formula 3a (without BiVO₄) shows that the white decoration changes colour (L*a*b * values=70.8; 2.8; 14.8).

The same configuration with the only difference that the decoration is yellow of formula 3c, shows that the yellow decoration does not change colour (L*a*b* values=76.1; −5.9; 72.0).

The decoration is protected from a colour change during the process of manufacturing the coating by the BiVO₄ contained in this decoration.

The same configuration with the only difference that the decoration is yellow of formula 3d shows that the yellow decoration changes colour: it is brown (L*a*b* values=56.4; 1; 42.2). The BiVO₄ pigment of formula 3d (Sicopal® K1120FG) is encapsulated, i.e., the BiVO₄ particles are covered. BiVO₄ then does not play its catalytic role since the encapsulation prevents it from contacting the degradation by-products.

### c. Configuration 3: Two Primer Coats without BiVO₄, Yellow Decoration Containing the BiVO₄ of Example 1 and Second Decoration Superposed on the First

A primer coat 1 of formula 1a is first deposited on the aluminium substrate. After drying, a primer coat 2 of formula 2a is coated onto the primer coat 1. After drying, a yellow decoration containing formula 3c is deposited onto the primer coat 2. After drying, a white decoration of formula 3a is deposited onto the preceding yellow decoration. After drying, a finish coat of formula 4 is coated onto the primer coat 2 and the decorations. The article is then sintered at 430° C. for 11 minutes.

Appearance: the decoration remains white with L*a*b* values=83.1, 0.4, 12.0. The white decoration is protected from a colour change during the process of manufacturing the coating by the BiVO₄ contained in the yellow decoration applied under the white decoration.

The same configuration with the only difference that the second decoration is yellow of formula 3d shows that the second yellow decoration does not change colour (L*a*b*values=75.5, 1.5, 72.5). The second yellow decoration is protected from a colour change during the process of manufacturing the coating by the BiVO₄ contained in the first decoration.

The same configuration with the only difference that the first decoration is yellow of formula 3d shows that the second white decoration (of formula 3a) changes colour (L*a*b*values=53.9, 9.4, 27.1). The second white decoration is not protected from a colour change during the process of manufacturing the coating by the BiVO₄ contained in the first decoration.

1. A method for reducing or preventing the colour change of a non-stick coating for household articles during the manufacturing process thereof, comprising the use of (Bi₁₋ₓAₓ)(V_{1-y}M_{y})O₄ wherein:
x is equal to 0 or x is between 0.001 and 0.999,
y is equal to 0 or y is between 0.001 and 0.999,
A and M are chosen in the group consisting of nitrogen, phosphorus, an alkali metal, an alkaline earth metal, a transition metal, a poor metal, a metalloid or a lanthanide,
A and M are different from one another.

2. The method according to claim 1, wherein x and y are 0.

3. The method according to claim 1, wherein the amount of (Bi₁₋ₓAₓ)(V_{1-y}M_{y})O₄ in each of the coats of said non-stick coating for household articles into which it is added is comprised from 0.1 to 100% by weight relative to the weight of said coat in the dry state.

4. The method according to claim 1, wherein A and/or M is an alkali metal chosen from Li, Na, K, Rb and Cs, A and M being different from one another.

5. The method according to claim 1, wherein A and/or M is an alkaline earth metal chosen from Be, Mg, Ca, Sr and Ba, A and M being different from one another.

6. The method according to claim 1, wherein A and/or M is a transition metal chosen from Sc, Ti, Cr, Mn, Fe, Co, Ni, Cu, Y, Zr, Nb, Mo, Ru, Rh, Pd, Ag, Ta, W and, Ir, A and M being different from one another.

7. The method according to claim 1, wherein A and/or M is a poor metal chosen from Al, Zn, Ga, In and Sn, A and M being different from one another.

8. The method according to claim 1, wherein A and/or M is a metalloid chosen from B, Si, Ge and Sb, A and M being different from one another.

9. The method according to claim 1, wherein A and/or M is a lanthanide chosen from La, Ce, Pr, Nd, Pm, Sm, Eu, Gd, Tb, Dy, Ho, Er, Tm, Yb and Lu, A and M being different from one another.

10. The method according to claim 1, wherein said non-stick coating for household articles comprises, in the following order from the face of the substrate of the household article on which it will be applied: one or more primer coats, and one or more finish coats.

11. The method according to claim 1, wherein said non-stick coating for household articles is a fluoropolymer-based coating.

12. The method according to claim 11, wherein the fluoropolymer(s) are chosen in the group comprising polytetrafluoroethylene (PTFE), copolymers of tetrafluoroethylene and perfluoropropyl vinyl ether (PFA), copolymers of tetrafluoroethylene and hexafluoropropene (FEP), polyvinylidene fluoride (PVDF), copolymers of tetrafluoroethylene and polymethyl vinyl ether (MVA), terpolymers of tetrafluoroethylene, polymethyl vinyl ether and fluoroalkyl vinyl ether (TFE/PMVE/FAVE) and ethylene tetrafluoroethylene (ETFE) and mixtures thereof.

13. The method according to claim 1, wherein (Bi₁₋ₓAₓ)(V_{1-y}M_{y})O₄ is added into a coat of said coating in order to reduce or prevent the colour change of this coat.

14. The method according to claim 13, wherein said coating comprises one or more decorations.

15. The method according to claim 14, wherein (Bi₁₋ₓAₓ)(V_{1-y}M_{y})O₄ is added into a decoration in order to reduce or prevent the colour change of this decoration.

16. The method according to claim 1, wherein (Bi₁₋ₓAₓ)(V_{1-y}M_{y})O₄ is added in a coat of said coating in order to reduce or prevent the colour change of another coat of the coating superposed on this coat.

17. The method according to claim 16, wherein (Bi₁₋ₓAₓ)(V_{1-y}M_{y})O₄ is added in a coat applied under a decoration in order to reduce or prevent the colour change of this decoration.

18. The method according to claim 1, in order to reduce or prevent the colour change of said coating during the sintering step of its manufacturing process.

19. The method according to claim 1, wherein said non-stick coating for household articles comprises, in the following order from the face of the substrate of the household article on which it will be applied: one or more primer coats, one or more continuous or discontinuous decorative coats, and one or more finish coats.
